(19) United States
(12) Patent Application Publication
(10) Pub. No.: US 2016/0125344 A1
(43) Pub. Date: May 5, 2016

(54) METHOD AND SYSTEM FOR DETECTION OF HUMAN RESOURCE FACTORS USING ELECTRONIC SOURCES AND FOOTPRINTS

(71) Applicants: Avraham CARMELI, Haifa (IL); Ran M. BITTMANN, Tel Aviv (IL); Roy GELBARD, Tel Aviv (IL)

(72) Inventors: Avraham CARMELI, Haifa (IL); Ran M. BITTMANN, Tel Aviv (IL); Roy GELBARD, Tel Aviv (IL)

(21) Appl. No.: 14/927,967

(22) Filed: Oct. 30, 2015

Related U.S. Application Data
(60) Provisional application No. 62/072,552, filed on Oct. 30, 2014.

(51) Int. Cl. G06Q 10/06

(52) U.S. Cl. CPC G06Q 10/06393

(57) ABSTRACT

A system and method for evaluating human factors by modeling their key performance indicators and defining their explanatory factors, manifestations and corresponding diverse electronic footprints in an organization's digital data. Six main human resource (HR) constructs (performance, engagement, leadership, workplace dynamics, organizational developmental support, and learning and knowledge creation) are translated into measurable electronic data.

### CROSS REFERENCE TO OTHER APPLICATIONS

This application claims priority from U.S. Provisional Patent Application No. 62/072,552 filed on Oct. 30, 2014 and incorporate herein by reference.

### TECHNICAL FIELD

The present invention relates to data mining in general, and in particular to data mining techniques that trace pattern and changes in human factor activities.

### BACKGROUND ART

Organizations are constantly looking for ways to assess human resource management activities to more effectively manage their resources and capabilities. Organizations often approach consulting firms and research institutions, or run their own processes to assess such human resource practices as employee commitment, engagement and satisfaction. For example, Gallup® conducts an ongoing study of the American workplace to assess employee engagement and its influence on both individual and organizational performance. In addition, scholars frequently use survey and experimental studies to explore why and how individuals, groups and organizations are motivated, act and perform. Despite the useful knowledge derived from these methods, they have several shortcomings. First, these methods rely on self-reports in which the participants provide information about the questions at hand. For example, when assessing employee commitment to an organization, researchers often ask employees to respond to a set of questions that measures the degree to which they are committed to the organization. Although subjective assessments are widely used in such fields as psychology and management, it is clear that these assessments have limitations and the results need to be interpreted with caution. Second, these methods are naturally resource and time consuming, as the employee needs to complete long surveys. Third, survey data do not provide real time assessments. Surveys can take variable lengths of time before they are collected and analyzed. But the key issue is the inability of organizations or researchers to approach potential subjects on a frequent basis. In fact many organizations are even reluctant to authorize researchers to conduct theoretical studies that involve surveying their members more than once a year. This does not even touch on the problems associated with administering different surveys to the same subjects under a tight time frame (e.g., unreliable data due to an emerging automatic response mode).

Human Factors: Definition and Assessment

Human factors research aims to develop a body of knowledge about human attributes, attitudes, abilities, and limitations within a particular context. As such, it has become a major area in various fields (e.g., psychology, organization and management, engineering) that focuses on a relatively wide variety of topics such as work environment, design, performance, work attitudes, withdrawal behaviors, feedback, leadership, learning and knowledge creation, creativity and innovation. Given its wealth of facets, individual studies tend to explore a single key construct. The disclosure provides, as mean of an example only, an overview of six key human factor constructs—performance, engagement, leadership, workplace relational dynamics, organization developmental support, and learning and knowledge creation—that are particularly relevant to the organizational workplace.

Performance

Performance at the individual, group and even the organization level is a complex task. Performance can take various forms, as it reflects a myriad of perspectives and focal points of research. For example, creativity researchers concentrate on creative performance whereas service scientists focus on service performance. However, a good way to begin conceptualizing performance is to distinguish between outcomes and behaviors. Six performance behaviors and outcomes are considered, as a mean of non-limiting example only: 1) Creativity refers to “the ability to produce work that is both novel (i.e., original or unexpected) and appropriate). i.e., useful or meets task constraints). Its key manifestations are number of ideas and their originality; 2) Innovation refers to the implementations of novel ideas such that the latter are realized in terms of number of new products, revenues derived from newly developed products, and product innovation (incremental, radical); 3) Service quality refers to the extent to which the service organizational members make customers loyal and satisfied. It is manifested in the number of repeat purchases and complaints or compliments; 4) Efficiency refers to the ratio of outputs (produced tasks) to inputs (e.g., efforts); 5) Effectiveness is often discussed in terms of goal attainment; 6) Organizational citizenship behaviors refer to “behavior(s) of a discretionary nature that are not part of the employee's formal role requirements, but nevertheless promote the effective functioning of the organization”.

Engagement

The engagement concept encompasses the essence of a motivational force of a particular activity or work behavior. Five elements are included that constitute state engagement: 1) Identification is a state engagement which refers to “the perception of oneness with or belongingness to an organization, where the individual defines him or herself in terms of the organization(s) in which he or she is a member”; 2) Work-family balance refers to “an overall appraisal of the extent to which individuals' effectiveness and satisfaction in work and family roles are consistent with their life values at a given point in time”; 3) Satisfaction refers to an emotional reaction to the job in which members express the extent to which they are content with what they do; 4) Vitality refers to the subjective feeling of being alive and alert. It can be manifested in a sense of aliveness and energy, denotes mental and psychological strength, and results in optimal functioning; 5) Withdrawal intentions (state engagement) “comprise several distinctive yet related constructs (e.g., thinking of quitting, intention to search, and intention to quit), which have been widely studied in relation to withdrawal behavior (e.g., absenteeism, actual turnover)”.

Leadership

Research on leadership tends to focus on three broadly defined behavior meta-categories: task-oriented behaviors (where the primary objective is to achieve efficiency and reliability outcomes), relationship-oriented behaviors (where the primary objective is to augment commitment, trust and cooperation among organizational members), and change-oriented behaviors (where the primary objective is to create a major transformation that results in substantial organizational improvements). There are a wide variety of behaviors that manifest each meta-category. For example, leader expectations focus on what tasks should be completed and the level of outcomes (e.g., efficiency, quality). Similarly, task orientation is determined by the goals and performance that a leader articulates and wishes to pursue. Relationships-oriented leadership includes feedback orientation where leaders can provide feedback to followers to help them develop and grow. Empowering leaders also focus on relationship orientations, as they aim to develop members' capability to lead without the presence of a formal leader and to support such autonomous structures, and thus allow for greater involvement and participation in the decision making process. Change-oriented leadership focuses on articulating a vision that guides paths that define the organization's identity, strategy, activities.

Thus, role modeling can be thought of a meta-construct for demonstrating task, relationships, and change-oriented behaviors. For example, leaders serve as role models for displaying task-orientation but they also send clear cues as to how to approach and interact with others (i.e., relationship orientations), as well as the extent to which they embrace new approaches and ideas and engage in their pursuit.

Workplace Relational Dynamics

Relationships are the living tissue that connects members and influences their capacity to thrive in the workplace. Relationships can take many forms from destructive (e.g., contempt) to constructive (e.g., support) or from depleting to life-giving. The disclosure focuses on four relationship constructs, as a way of non-limiting example, to illustrate the positive relational dynamics that can emerge and be assessed in the workplace. Trust is defined as “a psychological state comprising the intention to accept vulnerability based upon positive expectations of the intentions or behavior of another”. Members can develop trust in their employer, trust in leaders and trust in peers. Psychological safety is the psychological condition that defines people's perception that it is safe to take interpersonal risks and express their opinion and voice. In other words, psychological safety refers to “feeling able to show and employ one's self without fear of negative consequences to self-image, status, or career”. Connectivity refers relationships that are characterized by openness and generativity. Connectivity in relationships enables people to see the diverse influences that come from others as opportunities for learning and growth at work, and involves seeing the value in relationships for learning new things, generating new ideas, and seeking opportunities to explore and grow. Communication is probably the most prominent mode of interrelating that defines relationships among people. It is a multidimensional construct but can be thought of having two specific components: 1) the content of messages, in terms of members' satisfaction with what is being communicated, and 2) how the information is communicated among members within an organization. These are manifested by the extent to which the information that has been exchanged and shared is sufficient, accurate, timely, relevant, and creates the level of attention it intended to generate.

Organizational Support

Organizational support refers to members' perceptions of the degree to which an organization appreciates their effort and contribution and cares about their wellbeing. Organizational support has three facets: 1) organizational support that aims at caring for employee development, which can be achieved through a variety of practices such as training, job mobility, and mentoring; 2) organizational support that provides instrumental help and assistance by allocating the needed resources, tools and time frame for accomplishing tasks successfully while ensuring people's wellbeing; and 3) organizational support that reflects a behavioral orientation in which the organization values what individuals bring with them and shows interest in what they expect and need, builds their confidence, and gives them a sense of ownership.

Learning and Knowledge Creation

Learning is a process whereby new knowledge is created, exchanged and integrated. There are various modes of learning. These include learning from failure vs.

learning from success, or learning from direct experience vs. learning from indirect experience. Each mode of learning implies to different processes. Three fundamentals define the knowledge creation process: access to knowledge, exchange of knowledge, and combination of the knowledge that has been exchanged. in addition, knowledge bases can be unraveled to determine who knows what, and the extent to which the knowledge is credible.

### SUMMARY OF INVENTION

It is an object of the present invention to provide a system and method for calculating Key Performance Indexes (KPI's).

It is another object of the present invention to provide a system and method for calculating human resources Key Performance Indexes (KPI's).

It is a further object of the present invention to provide a system and method for calculating human resources Key Performance Indexes (KPI's) based on an organization digital data.

It is yet another object of the present invention to provide a system and method for calculating human resources Key Performance Indexes (KPI's) based on an organization digital data.

The present invention thus relates to evaluating human factors by modeling their key performance indicators and defining their explanatory factors, manifestations and corresponding diverse electronic footprints in an organization's digital data. Six main human resource (HR) constructs (performance, engagement, leadership, workplace dynamics, organizational developmental support, and learning and knowledge creation) are translated into measurable electronic data. By using data mining techniques (sentiment analysis and opinion mining) the system of the invention traces patterns and changes in a variety of human factor activities.

The present invention relates to a computerized system comprising a processor and non-transitory memory storing digital data of an organization, the system configured to quantitatively calculate a human resources key performance index (KPI) value in the organization at a given time point by reviewing the stored digital data, each KPI identified by a plurality of explanatory factors, the system comprising:

(i) a sensor module comprising a plurality of data collectors to constantly monitor usage of said digital data and reporting usage activity;

(ii) a data repository in the non-transitory memory for storing said usage activity;

(iii) a data collection module configured and programmed to clean and normalize said reported usage activity;

(iv) an analysis module comprising a plurality of predictive analytic tools to analyze the usage data stored in the data repository for identification of manifestations of the explanatory factors of said KPI;

(v) a modeling module configured and programmed to review the identified manifestations of the explanatory factors and calculate a KPI numeric value responsive to the review; and

(vi) a presentation module configured to convert the calculated KPI values into a graphical user interface that provides information about operations of the organization.

In some embodiments, a KPI is: performance, engagement, leadership, workplace relational dynamics, organization developmental support, or learning and knowledge creation.

In some embodiments, the KPI is a performance KPI, comprising:

(i) a creativity score calculated by scoring the number of ideas and their originality;

(ii) an innovation score calculated by scoring the number of new products, revenues derived from newly developed products, and product innovation;

(iii) a service quality score calculated by scoring the number of repeat purchases and complaints or compliments;

(iv) an efficiency score calculated by scoring the ratio of produced tasks to inputs;

(v) an effectiveness score calculated by scoring goal attainment;

(vi) an organizational citizenship score; or any combination thereof.

In some embodiments, the KPI is an engagement KPI, comprising:

(i) an identification score;

(ii) a work-family balance score;

(iii) a satisfaction score;

(iv) a vitality score;

(v) a withdrawal intentions score; or any combination thereof.

In some embodiments, the KPI is a leadership KPI.

In some embodiments, the KPI is a workplace relational dynamics KPI.

In some embodiments, the KPI is an organizational support KPI.

In some embodiments, the KPI is a learning and knowledge creation KPI.

In some embodiments, the presentation module is also configured to provide information about operations, changes, trends, states or any combination thereof in the organization.

In another aspect, the present invention relates to a computerized method comprising a processor and non-transitory memory storing digital data of an organization, the method configured to quantitatively calculate a human resources key performance index (KPI) value in the organization at a given time point by reviewing the stored digital data, each KPI identified by a plurality of explanatory factors, the method comprising the steps of:

(i) monitoring constantly usage of said digital data and reporting usage activity;

(ii) storing said usage activity in a data repository in the non-transitory memory;

(iii) cleaning and normalizing said reported usage activity;

(iv) analyzing the usage data stored in the data repository for identification of manifestations of the explanatory factors of said KPI;

(v) reviewing the identified manifestations of the explanatory factors and calculating a KPI numeric value responsive to the review; and

(vi) converting the calculated KPI values into a graphical user interface that provides information about operations of the organization.

### BRIEF DESCRIPTION OF DRAWINGS

FIG. 1 is a flow chart of the main steps of the method of the invention.

FIG. 2 is a block diagram with the main components of the invention.

FIG. 3 shows an embodiment of a client dashboard.

FIG. 4 shows eFootprints of change in the “engagement” pattern.

FIG. 5 shows eFootprints of change in the “Satisfaction” pattern.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a computerized system comprising a processor and non-transitory memory storing digital data of an organization. The system is configured to quantitatively calculate a human resources key performance index (KPI) value in the organization at a given time point by reviewing the digital data associated with the organization. Each KPI is identified by a plurality of explanatory factors. The disclosure below illustrates the system of the invention for calculating six human factors: performance, engagement, leadership, workplace relational dynamics, organizational developmental support, and learning and knowledge creation, as a way of example only. The system of the invention can be applied to any other KPI.

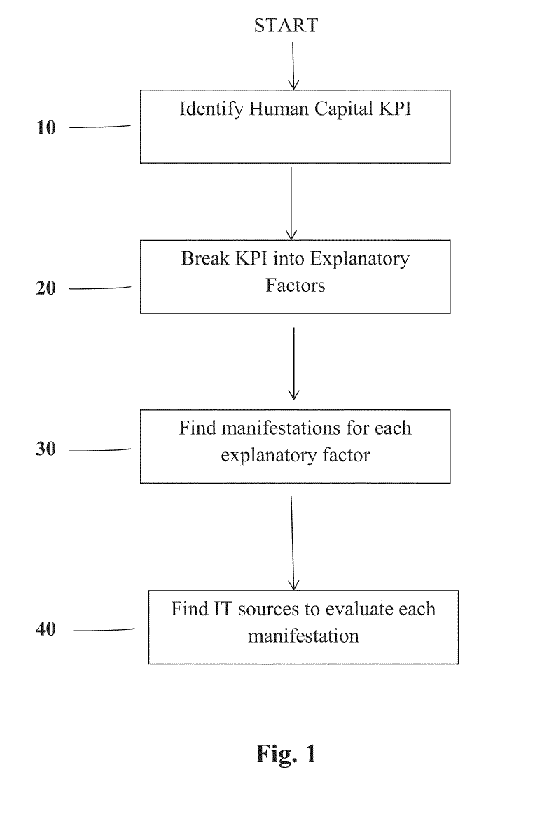

Reference is now made to FIG. 1 illustrating the method of the invention's building blocks in identifying the key performance indicators (KPIs) of human capital. The process starts at step 100. The first step 110 in the modeling process is to provide a conceptual definition of each human capital KPI, thus identifying each KPI. The second step 120 is to analyze each KPI and break it into explanatory factors. The third step 130 is to identify the key components that underlie the human capital KPI, that is, to find the manifestations for each explanatory factor. For example, the key components that underlie organizational support are support that is oriented towards employee development, means (instrumental) support and behavioral support. The fourth and last step 140 is finding the Information Technology (IT) digital sources for mining the data to assess the latent variables, their components and manifestations.

The system architecture supports a continuous process that monitors multiple electronic (digital) sources in an organization's information systems based on availability, and converts them into meaningful insights presented as KPI gauges for an “at a glance” status. It further enables system users to “drill down” when additional inquiry is required and correlations between KPIs and supporting events and facts are sought.

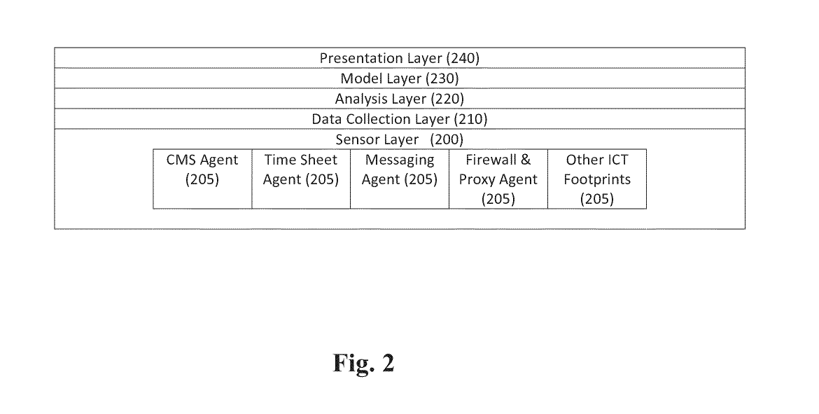

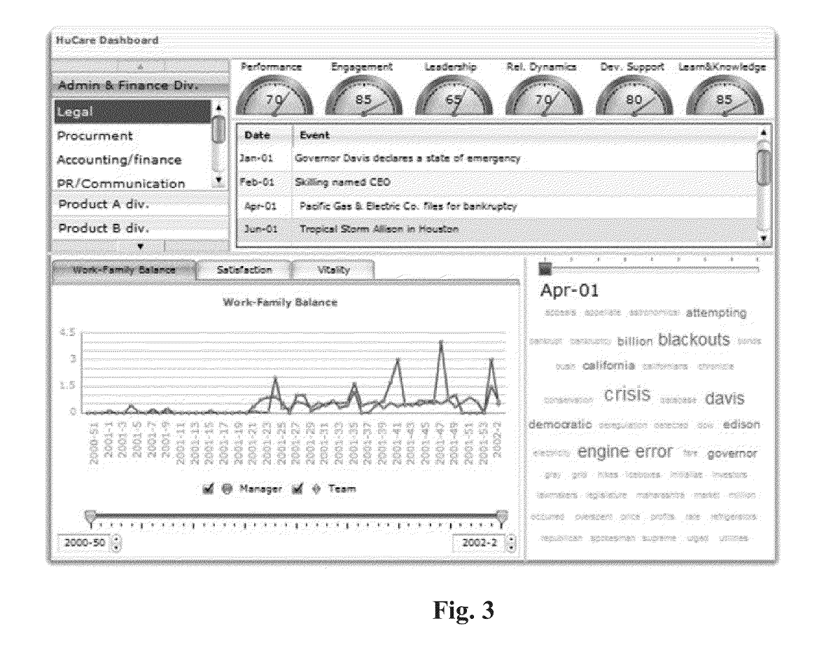

Reference is now made to FIG. 2 showing an exemplary block diagram of the architecture of the system of the invention. The system comprises 5 main components (layers):

(i) A sensor module 200 is the foundation of the system architecture and comprises a plurality of data collectors (agents) 205, that constantly monitor information system usage activity. The type and number of agents 205 can vary according to availability. Examples of agents 205 include: Content Management System (CMS) agents 205; time sheet agents 205; messaging agents 205; firewall and proxy agents 205; and other information and communications technology (ICT) agents 205. The collected data are reported up to the next layer, the data collection layer 210.

(ii) The data collection module (layer) 210 is configured and programmed to clean and normalize reported usage activity. The data collection module 210 is a federation layer that unifies the data collected into a data repository (not shown) in the non-transitory memory, and acts as a data warehouse. This is typically a database. This layer is also responsible for the cleaning, normalization and anonymizing of the data. For instance, information such as time of arrival at work can come from multiple sources. It can be a security card swipe, a clock punch or the first login on the computer. It is usually associated with a person's personal or professional ID. The collection module 210 is responsible for collecting these data from one or more of the agents 205 associated with these data sources, and based on the organization's privacy policy may replace the ID with a more general tag that cannot be associated with an actual person (e.g., someone from the IT department who has an arbitrary tag of 523194). Depending on the process supported by the layered architecture, the data in the repository are fed to the next layer, the analysis layer 220.

(iii) The analysis module (layer) 220 comprises a plurality of predictive analytic tools to statistical analyze the usage data stored in the data repository for identification of manifestations of the explanatory factors of the KPI to be calculated. The analysis module 220 is basically a collection of predictive analytic algorithms typically used to statistically analyze the data located in the data repository (warehouse). Examples of these tools are the R language for statistical computing (as disclosed on the Internet site www.r-project.org), or SAP HANA Predictive Analysis Library (as disclosed by SAP America, Inc. of 3999 West Chester Pike, Newtown Square, Pa. 19073, USA on its web page help.sap.com/hana). The analysis layer 220 serves as a toolbox for the next layer in the process, the model layer 230.

(iv) The modeling module (layer) 230 is configured and programmed to review the identified manifestations of the explanatory factors and calculate a KPI numeric value responsive to the review. The model layer 230 implements a constant assessment of the human capital KPIs based on the application of statistical tools and data collected in the previous layers. The model layer 230 essentially provides a real time numerical signature of the organization's health, based on state of the art human capital KPIs. The result of this layer feeds the final layer, the presentation layer 240.

(v) The presentation module (layer) 240 is the layer responsible for translating the numerical KPI values into a practical graphical user interface. The goal of this layer is to provide authorized users with an “at a glance” status of the organization's health, and enables further inquiries to pinpoint root causes and emerging events in real time.

Since the field of real time human factor evaluation is still very new, special care is needed to define this graphical user interface. Some key GUI considerations include, but are not limited to:
The “at a glance” dashboard that displays the current health status of the organization.
Drilling from the dashboard to a more detailed presentation of multiple dimensions, e.g. in terms of organization, time, manifestation or explanatory factors.
Correlation of supporting data such as popular keywords or significant events in the organization.

### Electronic Footprints as Manifestations of Human Factor KPIs—Examplary KPI's

Studies of the art frequently use surveys as a method for assessing human factors. The system and method of the invention offer a different approach that involves assessing the electronic footprints of a wide variety of human factors. Tables 1-6 present six human factors: performance, engagement, leadership, workplace relational dynamics, organizational developmental support, and learning and knowledge creation as a way of non-limiting examples. Drawing on published literature, the explanatory factors for each KPI and their manifestations are specified. A potential electronic source is then suggested to assess each factor] (C=Calendar, E=Email, F=Forums and Portals, H=HR & Reports; M=Manuals, Q =Quality Assurance, R=Releases, T=Tasks (Project Management Office (PMO)), and Z=Others), the frequency of data collection (Y=Year, Q=Quarter, M=Month, W=Week), and the formatting representation (Abs=Absolute, Delta, Per=Percentage Change).

Table 1 provides an illustrative application. For example, when assessing human performance, one can evaluate members' creativity, innovation, service quality, efficiency and effectiveness, and extra-role behaviors (citizenship).

Creativity can be assessed through managers' evaluation of their employees. This is likely to take place on an annual basis but in organizations where there is a more frequent performance evaluation process (e.g., every six months) it can be adjusted accordingly. For assessing innovation, one can use organizational and external records to tabulate the number of newly developed products/services through organizational records, the number of patents through IP submissions, product quality through QA reports, sales derived from new products using the financial statements, and development speed through the PMO. Service quality can be assessed by investigating the level of customer loyalty, satisfaction, as well as the delta in sales from services. Customer loyalty can be assessed through meeting cancellations or mobility on a weekly basis. Customer satisfaction can be assessed by organizational records that contain electronic service evaluation forms and complimentary letters. Change in sales from service activities can be assessed annually using the financial reports.

TABLE 1
eFootprints of the “Performance” Factor
Performance

| Components - | | | | | |
|---|---|---|---|---|---|
| Explanatory | | | Source | Frequency | Units |
| Factors | Manifestations | Sources | Cat | Y-Q-M-W-D | Abs-Prc |
| Creativity | Fluency = No of Ideas | Manager's Manual evaluation | M | Y | Abs |
| | No. Idea Categories = Flexibility | | | | |
| | Original Ideas | | | | |
| | Elaboration = Detailed level | | | | |
| Innovation (Ideas | No of Developed Products | Involvement in the development of X Releases | R | Q | Abs |
| that have been | IP (Patents etc) | IP's Submissions | M | Q | Abs |
| Realized) | Product Quality | QA rate | Q | Q | Abs |
| | Sales of new Products | — | | | |
| | Development Speed | Tasks on time (since initiation) | T | W | Per |
| Service Quality | Customer Loyalty | Meeting cancellations or moving | C | W | Per |
| | Customer Satisfaction | — | | | |
| | Delta of Service Sales | — | | | |
| Efficiency | Completion Tasks on Time | Tasks on time (development) | T | W | Per |
| | Completion Tasks with | Tasks an budget and resources (development) | T | W | Per |
| | Allocated Resources | | | | |
| | Quality of Completed Tasks | QA rate | Q | M | Per |
| | Realized Capacity (Task Load) | Over or irregular hours | C | W | Per |
| Effectiveness | Goals-Objectives Meeting | Tasks on time and budget | T | W | Per |
| Org. Citizenship | Altruism (Helping Others) | Peer performance (Tasks on time) | T | W | Per |
| | Generosity (Doing Favors) | Response to questions in forums/portal | F | W | Abs |

TABLE 2
eFootprints of the “Learning & Knowledge Creation” Factor
Learning and Knowledge Creation

| Components - | | | | | |
|---|---|---|---|---|---|
| Explanatory | | | Source | Frequency | Units |
| Factors | Manifestations | Sources | Cat | Y-Q-M-W-D | Abs-Prc |
| Learning | Learning from failure | Portal updating frequency | F | W | Abs |
| | Learning from Success | | | | |
| | Learning from direct experience | Time spend in firm portal | | | |
| | Learning from indirect | Time spend in external forums/Pro. Sites | F | W | Abs |
| | experience | | | | |
| Knowledge creation | Who knows what | Personal appeal vs. forum surfing | F | M | Per |
| | Knowledge credibility | Number of rounds in discussions | F | W | Per |
| | Access to knowledge | Volume of users | F | W | Abs |
| | Knowledge exchange | Uploads - volume and frequency | F | W | Abs |
| | Knowledge combination | — | | | |

TABLE 3
eFootprints of the “Engagement” Factor
Engagement

| Components - | | | | | |
|---|---|---|---|---|---|
| Explanatory | | | Source | Frequency | Units |
| Factors | Manifestations | Sources | Cat | Y-Q-M-W-D | Abs-Prc |
| Identification | Belongingness = Alignment | Absence from company meetings (voluntary/ | C | Q | Per |
| | (Shared Values) | Social) | | | |
| | Meaningfulness | — | | | |
| Work-Family | Amount of Working Time | Volume and hours worked | C | W | Abs |
| Balance | Psychological Involvement at | Standard Deviation of working hours | C | M | Abs |
| | Home | (high = Home involved) | | | |
| | Psychological Involvement at | Email checking Frequency (High = Work | e | D | Abs |
| | Work | involved) & eMailing beyond work time | | | |
| | Satisfaction (of current | Absences | C | M | Abs |
| | balance) | | | | |
| Satisfaction | Emotional Response to the | Response time to Emails | e | W | Delta |
| | work | | | | |
| | Emotional Response to the | Role change requests | H | Q | Abs |
| | Job Role | | | | |
| | Overlap between Expectations | Increase in expenditure reports & Frequency | H | M | Abs |
| | and Returns | of meetings with HR officers | | | |
| Vitality (Vigor/ | Sense of Aliveness | Emails - Response time, length, degree of | e | D | Abs |
| Passion) | Energetic | detail | | | |
| | Fully Functioning | | | | |
| | Mental Strength | | | | |
| | Physical Strength | Sick days | C | M | Abs |
| | Feeling Good | Positive gestures in Emails (smiley) | e | W | Per |
| Withdrawal | Thoughts | Changing in absences pattern & Any | C | M | Delta |
| Intentions | | Organizational change | | | |
| | Search | on sites such as Linkedin, JobInfo | z | M | Per |
| | Alternatives | Labor market | z | Q | Abs |
| | Absenteeism | Breaks, Sick days, Lateness, Work hours, | C | W | Abs |
| | | Personal time | | | |

TABLE 4
eFootprints of the “Organization Support” Factor
Organization Developmental Support

| Components - | | | | | |
|---|---|---|---|---|---|
| Explanatory | | | Source | Frequency | Units |
| Factors | Manifestations | Sources | Cat | Y-Q-M-W-D | Abs-Prc |
| Employee | Training | Training | H | Q | Abs |
| development | Certification | Certification | H | Q | Abs |
| | Job mobility | Job mobility | H | Q | Abs |
| | Promotion | Promotion | H | Q | Abs |
| | Mentoring | — | | | |
| Means Support | Resources | Average employee overhead | z | Q | Abs |
| | Tools | | | | |
| | Time availability | Time welfare and enrichment lectures | C | Q | Abs |
| Behavioral Support | Value | — | | | |
| | Interest | — | | | |
| | Confidence | — | | | |
| | Psychological Ownership | — | | | |

TABLE 5
eFootprints of the “Leadership” Factor
Leadership

| Components - | | | | | |
|---|---|---|---|---|---|
| Explanatory | | | Source | Frequency | Units |
| Factors | Manifestations | Sources | Cat | Y-Q-M-W-D | Abs-Prc |
| Feedback | Constructive-Positive-Non | Changes in patternso Emails after periodic | e | W | Delta |
| | Judgmental | evaluations | | | |
| | Specific Feedback | positive change indicates for leadership and | | | |
| | | engagement | | | |
| | Developmental = Useful | | | | |
| | Information | | | | |
| Empowerment | Developed Capabilities to Self | Scope of external contacts used by the team | e | M | Per |
| | Leadership (Mentoring) | Scope of applications for director's approval | e | M | Per |
| | Centralized vs. Decentralized | | | | |
| Task Orientation | Motivation by Goals | strict adherence in task-reports filing | T | W | Per |
| | Focus on Performance | Tasks on time | T | W | Per |
| Vision | Future Positions - Products | Appearance and development of new elements | T | M | Abs |
| | Future Positions - Customer | | | | |
| | Groups | | | | |
| | Future Positions - Geographic | | | | |
| | Scope (New Markets) | | | | |
| Expectations | High vs. Low | Task load compared to other teams | T | M | Abs |
| | Realistic-Social Norms | Task completion compare to other teams | T | M | Per |
| Role modeling | Modeling Actions | Response to manager's Emails | e | W | Per |
| | Modeling Behaviors | Absence from team meetings | C | M | Per |
| | Daily Practices | — | | | |

TABLE 6
eFootprints of the “Workplace Dynamics” Factor
Workplace Relational Dynamics

| Components - | | | | | |
|---|---|---|---|---|---|
| Explanatory | | | Source | Frequency | Units |
| Factors | Manifestations | Sources | Cat | Y-Q-M-W-D | Abs-Prc |
| Trust = | Trust in employer | Frequency of meetings with HR officers | H | Q | Delta |
| Willingness to | Trust in leaders | Email pattern change - Manager | e | Q | Delta |
| Accept | Trust in peers | Email pattern change - Peers | e | Q | Della |
| Vullenrability | | | | | |
| Psychological | Take inter Personal Risk | Absence from team meetings | C | Q | Per |
| safety | to Voice Options | Criticism - text analysis | e | Q | Abs |
| Connectivity - | Generativity - Employee | | | | |
| Relational | Productivity Space | | | | |
| Connection | | | | | |
| | Openness | Raising questions in forums/portal | F | M | Abs |
| Communication | Information Sufficiency | Portal updating frequency | F | W | Abs |
| | Information Accuracy | | | | |
| | On Time Information | | | | |
| | Information Relevancy | Positive evaluations of portal items | F | W | Abs |
| | Attention | Time spent in portal forums | F | W | Abs |

Efficiency can be assessed by the completion of tasks on time through the PMO, completion of tasks with the allocated resources using the PMO for budgetary evidence, quality of the completed tasks using QA reports, and task load by calculating the number of overtime hours spent on a weekly basis. Effectiveness can be assessed through the evaluation of tasks that were completed on time and were within or exceeded the allocated budget. Finally, organizational citizenship behaviors can be assessed through peer behavior evaluations and members' responses to queries in forums on the organizational portal.

### EXAMPLE

### Analyzing Enron's Email Corpus

Following is an example to illustrate the approach and conceptualization of the invention by using a specific electronic source—electronic mail—which appears and serves, with specific variance, all of the KPIs. One use of this electronic source is to unravel and understand sentiment. For example, Table 3 explores engagement one of whose explanatory factors is vitality, which is manifested by such feelings as a sense of aliveness and feeling good. These manifestations can be extracted from positive gestures in emails. The example shows adjustments made using common techniques of sentiment analysis. These adjustments are required to apply sentiment analysis concepts to emails in which the content has to do with organizational work. This adjustment and its utility are examined using the Enron Email Corpus.

The purpose of sentiment analysis is to analyze textual documents to identify the emotional attitude of the authors towards certain phenomena (e.g., movies that they watch or events in organizations for which they work). Employee emails from the Enron email corpus were analyzed to identify the sentiments of the Enron corporation employees as a whole, rather than individual employees. To achieve this goal the sentiment of each individual email was estimated and then individual estimates were aggregated over a few weeks for all employees.

A widely used approach to sentiment analysis is based on classifiers which is a machine learning tool. To tune their parameters, classifiers require a tagged corpus as input; namely a set of text documents, where each document is tagged by one sentiment tag (e.g. positive, negative or neutral). One of the challenges faced while constructing a sentiment analysis for the Enron corpus was that it is very imbalanced: only a very small percentage of the emails have either positive or negative sentiment, whereas the vast majority of the emails are neutral. The percent of non-neutral emails was below 0.1%. Normally it is very hard to achieve high classification accuracy from such imbalanced corpora.

To overcome the above Bittmann-Talyansky concept was used, so the classifier had much better accuracy: about half of the emails tagged as having a positive (negative) sentiment, indeed had a positive (negative) sentiment, whereas the vast majority of the neutral emails were tagged with tag neutral. This level of accuracy was sufficient to reveal fluctuations in sentiment of the Enron employees as a whole over time (e.g., after the CEO of Enron was replaced, or when the employees accepted the new CEO). In general, the correlation between the sentiment analysis along the time axis and important events in Enron history were used to validate the approach of the invention for estimating the sentiment of employees in an organization as a whole.

As Bittmann-Talyansky suggest: to build an organizational sentiment analysis, a naive Bayes classifier was used. Let C be the set of classes. The naive Bayes classifier treats each document as the set of its words. It also assumes that for each word w, the probability to observe w in document d, given class c, may be written as follows

$$Pr ( d \vert c ) = {\prod }_{w ∈ d} Pr ( w \vert c ) , \qquad ( 1.1 )$$

This assumption means that given class C, words in the document are independent of other words in the document, their relative position in d, the length of the document and any other context of the document. This independency assumption gave rise to the name of the classifier.

Next, from the Bayes theorem the probability of a class, given a document, may be written as follows

$$Pr ( c \vert d ) = \frac{Pr ( c ) Pr ( d \vert c )}{Pr ( d )} . \qquad ( 1.2 )$$

Using this expression, the classification function is defined as follows: given document d, choose class C that maximizes the above probability

classify(d)=max_{c}Pr(c|d).

Since the denominator of expression (1.2) does not depend on c, the classification function may be rewritten as follows

classify(d)=max_{c}Pr(c)Pr(d|c)

Using (1.1) we get

$$classify ( d ) = {max}_{c} Pr ( c ) {\prod }_{w ∈ d} Pr ( w \vert □ ) .$$

To make the above derivations applicable in practice, the probabilities Pr(□) and Pr(w|c) are estimated from a training corpus that consists of a set of documents D, where each document d ∈ D is assigned a class c ∈ C.

Using the Enron Email Corpus to Illustrate Workplace Dynamics

The Enron Email Corpus was used in an attempt to validate the argument that human capital KPIs can be evaluated by the analysis of the use of information systems in an organization. The Enron email dataset was made public by the Federal Energy Regulatory Commission during its investigation. The original database had over 600,000 emails generated by 158 employees. It contained all kinds of emails, both personal and official. Some of the emails were deleted as part of a redaction effort prompted by requests from employees. In the analysis a clean version of the dataset was used containing 250K email messages generated by 151 employees. The first task was to isolate a unit in the organization and analyze its e-mail correspondence. By examining the joint e-mail correspondence we identified groups of employees who exchanged messages frequently. By examining these messages, the managers were then identified and by examining a manager's focal group messages it was possible to verify the whole unit. External web data (e.g., LinkedIn) was used to further corroborate the findings. Hence it was possible to extract the legal unit and identify its manager.

Another task was to identify significant events in the period covered by the corpus, between week 32 of 2000 and week 9 of 2002. The relevant events were:

A. W:7 Y:2001—Skilling named CEO of Enron.

B. W:33 Y: 2001—Skilling resigns, Lay named CEO again.

C. W:42 Y:2001—Securities launch inquiry.

D. W:48 Y:2001—Enron goes bankrupt, thousands of workers laid off.

Vitality Evaluation

The experiments were conducted as follows: First, we tried to evaluate vitality, which is an explanatory factor of engagement. We used the ratio between e-mails sent during off-work hours and work hours; i.e.

$$V = \frac{{E}_{o}}{{E}_{w}}$$

$$V = Vitality$$

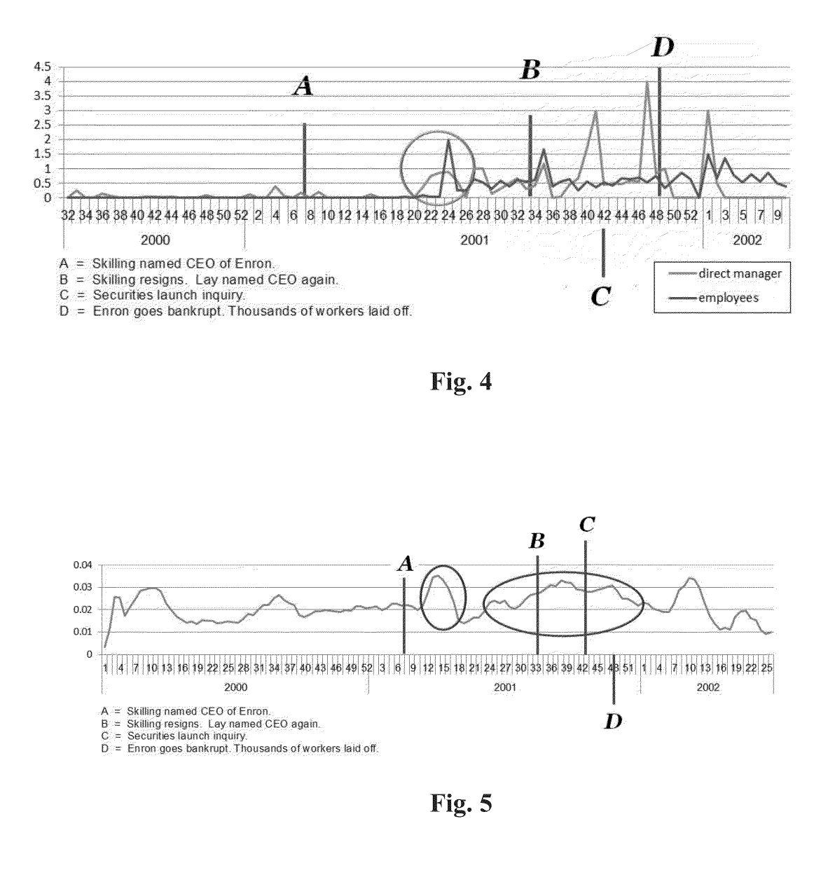

The findings in FIG. 4, which show vitality to be the explanatory factor for the group and the manager, indicate that vitality was significantly affected by the events. Before Skilling's resignation and the securities inquiry, there were significant changes in employees' vitality. An interesting observation concerns the manager's level of vitality, which changed about two weeks earlier than his/her group vitality. This can be explained by the likelihood that the manager had access to information regarding the state and functioning of the organization that was unavailable to other employees.

Sentiment Analysis

The second experiment involved sentiment in the company. It analyzed the aggregated sentiment in the e-mails and compared them to the above events. The findings in FIG. 5, where satisfaction is measured, show how sentiment in the company was influenced by the events. In event A, the company's CEO was replaced. In such a situation, when CEOs are fired because of considerable problems, uncertainty can be expected but also some hope for change and improved outcomes. As can be seen from FIG. 5, the negative sentiment in the organization increased during the adaptation period, but then gradually decreased to even below the starting point, implying that the new CEO was well accepted as someone who could provide a more positive orientation for the company. But because the organization faced increased pressure and the CEO had to resign, the second replacement (Event B) was less successful (since members are likely to lose hope and develop mistrust toward this change), and as the results indicate, sentiment never recovered until Enron folded.

Conclusion

The claim that “the people make the place” is as true as it was more than 25 years ago. Thus, understanding people's attitudes, intentions, and behaviors is fundamental to cultivating improved work processes and outcomes. Perceptions people have about their work and organization shape how they behave in the workplace, which in turn has implications for what takes place in their units and organizations and how they function. However, understanding people's perceptions and behaviors is a complex task. Conventional tools (e.g., survey-based data collection) to assess employees' perceptions not only require a substantial use of resources, but also have limitations that call for caution when interpreting the data since subjective information is often inflated and biased and real time assessment is seldom feasible. Although the Enron email corpus feasibility test demonstrated the predictability of only one specific dimension and was limited to only one electronic footprint (e-mail correspondence), this provides evidence for the potential usefulness of the system and method of the invention for understanding and analyzing human factors in organizations since it was able to pinpoint sentiments clearly.

The system and method of the invention provide a reliable and convenient way for estimating human factors using electronic sources and footprints available in any organization through its information systems. Further, it also enables the integration of a myriad of perspectives that inform individual and group level behaviors in organizations. Using the invention enhances the organization's capacity for tracing and predicting emerging behavioral patterns. This, in turn, enables the organization to engage in “preventive actions” or “promoting actions” that can shape behavior towards a desired end; for example, tracking how a new management team is accepted by the organizational members can shed light on what messages should be communicated to persuade individuals that the new strategic orientation is robust and facilitate further engagement in the new direction.

Privacy concerns regarding use of the invention inside an organization can be addressed on several levels. First, the data can be extracted and analyzed in such a way that does not reveal individual identification, such that the preservation of data is used by technical identifiers and personal identification is deleted. Second, the data should be aggregated such that individual members are not the core issue. Third, the analysis and presentation of the results should focus on patterns of behaviors rather than values. Fourth, instead of content-based processing, organizations and researchers need to adopt technical text-based processing, similar to anti-virus or fraud detection programs that search for patterns in the text rather than content.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

1. A computerized system comprising a processor and non-transitory memory storing digital data of an organization, the system configured to quantitatively calculate a human resources key performance index (KPI) value in the organization at a given time point by reviewing the stored digital data, each KPI identified by a plurality of explanatory factors, the system comprising:
(i) a sensor module comprising a plurality of data collectors to constantly monitor usage of said digital data and reporting usage activity;
(ii) a data repository in the non-transitory memory for storing said usage activity;
(iii) a data collection module configured and programmed to clean and normalize said reported usage activity;
(iv) an analysis module comprising a plurality of predictive analytic tools to analyze the usage data stored in the data repository for identification of manifestations of the explanatory factors of said KPI;
(v) a modeling module configured and programmed to review the identified manifestations of the explanatory factors and calculate a KPI numeric value responsive to the review; and
(vi) a presentation module configured to convert the calculated KPI values into a graphical user interface that provides information about operations of the organization.

2. The system according to claim 1, wherein a KPI is: performance, engagement, leadership, workplace relational dynamics, organization developmental support, or learning and knowledge creation.

3. The system according to claim 2, wherein the KPI is a performance KPI, comprising:
(i) a creativity score calculated by scoring the number of ideas and their originality;
(ii) an innovation score calculated by scoring the number of new products, revenues derived from newly developed products, and product innovation;
(iii) a service quality score calculated by scoring the number of repeat purchases and complaints or compliments;
(iv) an efficiency score calculated by scoring the ratio of produced tasks to inputs;
(v) an effectiveness score calculated by scoring goal attainment;
(vi) an organizational citizenship score; or any combination thereof.

4. The system according to claim 2, wherein the KPI is an engagement KPI, comprising:
(i) an identification score;
(ii) a work-family balance score;
(iii) a satisfaction score;
(iv) a vitality score;
(v) a withdrawal intentions score; or any combination thereof.

5. The system according to claim 2, wherein the KPI is a leadership KPI.

6. The system according to claim 2, wherein the KPI is a workplace relational dynamics KPI.

7. The system according to claim 2, wherein the KPI is an organizational support KPI.

8. The system according to claim 2, wherein the KPI is a learning and knowledge creation KPI.

9. The system according to claim 1, wherein the presentation module is also configured to provide information about operations, changes, trends, states or any combination thereof in the organization.

10. A computerized method comprising a processor and non-transitory memory storing digital data of an organization, the method configured to quantitatively calculate a human resources key performance index (KPI) value in the organization at a given time point by reviewing the stored digital data, each KPI identified by a plurality of explanatory factors, the method comprising the steps of:
(i) monitoring constantly usage of said digital data and reporting usage activity;
(ii) storing said usage activity in a data repository in the non-transitory memory;
(iii) cleaning and normalizing said reported usage activity;
(iv) analyzing the usage data stored in the data repository for identification of manifestations of the explanatory factors of said KPI;
(v) reviewing the identified manifestations of the explanatory factors and calculating a KPI numeric value responsive to the review; and
(vi) converting the calculated KPI values into a graphical user interface that provides information about operations of the organization.

11. The method according to claim 10, wherein a KPI is, but not limited to:
performance, engagement, leadership, workplace relational dynamics, organization developmental support, or learning and knowledge creation.

12. The method according to claim 11, wherein the KPI is a performance KPI, comprising:
(i) a creativity score calculated by scoring the number of ideas and their originality;
(ii) an innovation score calculated by scoring the number of new products, revenues derived from newly developed products, and product innovation;
(iii) a service quality score calculated by scoring the number of repeat purchases and complaints or compliments;
(iv) an efficiency score calculated by scoring the ratio of produced tasks to inputs;
(v) an effectiveness score calculated by scoring goal attainment; and
(vi) an organizational citizenship score.

13. The method according to claim 10, wherein the KPI is an engagement KPI, comprising:
(i) an identification score;
(ii) a work-family balance score;
(iii) a satisfaction score;
(iv) a vitality score;
(v) a withdrawal intentions score or any combination thereof.

14. The system according to claim 11, wherein the KPI is a leadership KPI.

15. The method according to claim 11, wherein the KPI is a workplace relational dynamics KPI.

16. The system according to claim 2, wherein the KPI is an organizational support KPI.

17. The method according to claim 10, wherein the KPI is a learning and knowledge creation KPI.

18. The method according to claim 10, wherein the presentation module is configured to provide information about operations, changes, trends, states or any combination thereof of the organization.
